(19) United States
(12) Patent Application Publication
(10) Pub. No.: US 2026/0079422 A1
(43) Pub. Date: Mar. 19, 2026

(54) STATIC ELIMINATOR, IMAGE FORMING SYSTEM, AND ELECTRIC CHARGE ADJUSTMENT APPARATUS

(71) Applicant: CANON KABUSHIKI KAISHA, Tokyo (JP)

(72) Inventor: YOSUKE HATA, Chiba (JP)

(21) Appl. No.: 19/325,219

(22) Filed: Sep. 10, 2025

(30) Foreign Application Priority Data
Sep. 13, 2024 (JP) 2024-159543

(51) Int. Cl. G03G 15/02; G03G 15/00

(52) U.S. Cl. CPC G03G 15/0291; G03G 15/5016; G03G 15/6552; G03G 15/6573

(57) ABSTRACT

An image forming system includes an image forming apparatus configured to form an image on a sheet, and a static eliminator having a charge eliminating component configured to neutralize a sheet having an image formed by the image forming apparatus. The static eliminator includes a first setting unit configured to set a voltage to be applied to the charge eliminating component. The image forming apparatus includes a second setting unit configured to set a voltage to be applied to the charge eliminating component. The image forming system includes a third setting unit configured to set which voltage is applied as a voltage to be applied to the charge eliminating component, the voltage set by the first setting unit or the voltage set by the second setting unit.

### BACKGROUND

### Field of the Technology

The present disclosure relates to a static eliminator that neutralizes sheets, an image forming system including the static eliminator, and an electric charge adjustment apparatus that adjusts the electric charge of sheets.

### Description of the Related Art

In image forming apparatuses, there are cases where sheets are electrostatically charged during image formation, the sheets stick to each other by electrostatic force produced between the discharged sheets and, as a result, improper stack occurs. Japanese Patent Laid-Open No. 2024-108112 suggests an image forming apparatus equipped with a static eliminator that neutralizes sheets. The static eliminator described in Japanese Patent Laid-Open No. 2024-108112 includes a switch to change over the on or off state of neutralization using charge eliminating rollers.

As an apparatus to suppress the sticking of sheets to each other, Japanese Patent Laid-Open No. 2022-171206 suggests an electric charge adjustment apparatus that applies voltage to every other sheet being fed to electrostatically charge the surfaces of the stacked sheets to have the same polarity.

Incidentally, various settings related to printing are often made at an operating unit provided on the main body of an image forming apparatus. Therefore, the settings related to neutralization and electric charge adjustment can also be set via the operating unit provided on the main body of the image forming apparatus. However, in an image forming system, if settings related to neutralization and electric charge adjustment can be made via both the operating unit provided on the main body of the image forming apparatus and the operating unit provided on the static eliminator, there is a possibility that the settings via these multiple operating units are inconsistent. In such cases, there has been an inconvenience that leads to user confusion and a decrease in usability.

### SUMMARY

The present disclosure improves usability when settings related to neutralization and charge adjustment of sheets are performed.

One aspect of the present disclosure is an image forming system. The image forming system includes an image forming apparatus configured to form an image on a sheet, and a static eliminator having a charge eliminating component configured to neutralize a sheet having an image formed by the image forming apparatus. The static eliminator includes a first setting unit configured to set a voltage to be applied to the charge eliminating component. The image forming apparatus includes a second setting unit configured to set a voltage to be applied to the charge eliminating component. The image forming system includes a third setting unit configured to set which voltage is applied as a voltage to be applied to the charge eliminating component, the voltage set by the first setting unit or the voltage set by the second setting unit.

Additionally, another aspect of the present disclosure is an image forming system. The image forming system includes an image forming apparatus configured to form an image on a sheet, and a static eliminator having a charge eliminating component configured to neutralize a sheet having an image formed by the image forming apparatus. The static eliminator includes a first setting unit configured to set a voltage to be applied to the charge eliminating component. The image forming apparatus includes a second setting unit configured to set a voltage to be applied to the charge eliminating component. The image forming system further includes a control unit configured to control which voltage is applied as a voltage to be applied to the charge eliminating component, the voltage set by the first setting unit or the voltage set by the second setting unit. The control unit is configured to, when a value of the voltage set by the first setting unit is changed, apply the voltage set by the first setting unit as a voltage to be applied to the charge eliminating component, and, when a value of the voltage set by the second setting unit is changed, apply the voltage set by the second setting unit as a voltage to be applied to the charge eliminating component.

Additionally, another aspect of the present disclosure is a static eliminator connected to an image forming apparatus that forms an image on a sheet. The static eliminator includes a charge eliminating component configured to neutralize a sheet having an image formed by the image forming apparatus, a first setting unit configured to set a voltage to be applied to the charge eliminating component, and a third setting unit configured to set which voltage is applied as a voltage to be applied to the charge eliminating component, the voltage set by the first setting unit or a voltage set by a second setting unit disposed in the image forming apparatus and configured to set a voltage to be applied to the charge eliminating component.

Additionally, another aspect of the present disclosure is an electric charge adjustment apparatus connected to an image forming apparatus that forms an image on a sheet. The electric charge adjustment apparatus includes an electric charge supply member configured to supply electric charge to a sheet having an image formed by the image forming apparatus, a first setting unit configured to set a voltage to be applied to the electric charge supply member, and a third setting unit configured to set which voltage is applied as a voltage to be applied to the electric charge supply member, the voltage set by the first setting unit or a voltage set by a second setting unit disposed in the image forming apparatus and configured to set a voltage to be applied to the electric charge supply member.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic sectional view of an image forming system.

FIG. 2 is a copy settings screen of an operating unit of an image forming apparatus.

FIG. 3 is a schematic sectional view of a static eliminator.

FIG. 4 is an operating unit of the static eliminator.

FIG. 5 is a neutralization settings screen of the operating unit of the image forming apparatus.

FIG. 6 is a block diagram of the image forming system.

FIG. 7 is a flowchart of a CPU of the image forming apparatus according to a first embodiment.

FIG. 8 is a flowchart of a CPU of the static eliminator according to the first embodiment.

FIG. 9 is a modification of the operating unit of the static eliminator.

FIG. 10 is a flowchart of the CPU of the image forming apparatus according to a second embodiment.

### DESCRIPTION OF THE EMBODIMENTS

Hereinafter, embodiments of the present disclosure will be described with reference to the attached drawings.

### First Embodiment

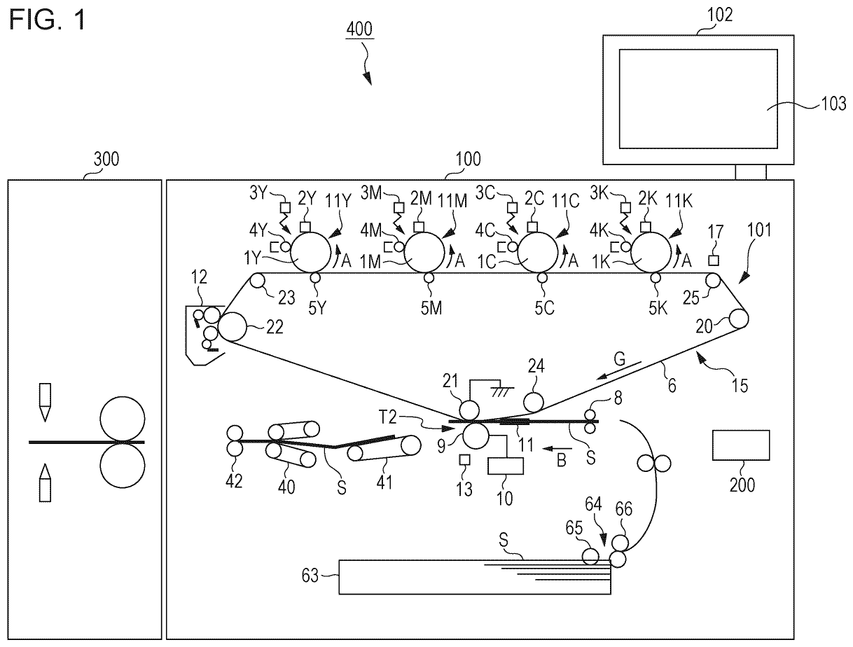

FIG. 1 is a schematic diagram of an image forming system 400 according to the first embodiment. The image forming system 400 includes an image forming apparatus 100 (image forming apparatus main body, printer) and a static eliminator 300 connected to the image forming apparatus 100. The image forming system 400 forms an image on a sheet S and discharges the sheet S as a product. Various sheet materials of different sizes and materials, including paper, such as plain paper and thick paper, sheet materials with surface treatment like coated paper, special-shaped sheet materials, such as envelopes and index paper, plastic sheet materials, and cloth, can be used as the sheet S that is a recording material (recording medium). Examples of plastic sheet materials include synthetic paper made primarily from synthetic resin and sheets (OHT) for overhead projectors.

The static eliminator 300 is an apparatus having a neutralization function of removing (reducing) the electric charge of a sheet S discharged from the image forming system 400. The static eliminator 300 can also be referred to as an electric charge adjustment apparatus for adjusting the charged state of a sheet S discharged from the image forming system 400. The static eliminator 300 may have functions other than the neutralization function (for example, a decurling function of correcting the curl of a sheet S). The static eliminator 300 of the present embodiment is disposed as an independent apparatus connected to the image forming apparatus 100.

The image forming system 400 may include optional devices other than the static eliminator 300. Examples of the optional devices include a large-capacity feeding device (optional feeder) that supplies sheets S to the image forming apparatus 100, and a sheet processing device (finisher) that performs processes, such as binding, on sheets S having images formed by the image forming apparatus 100. Another apparatus, such as an inserter, may be connected between the image forming apparatus 100 and the static eliminator 300. In this case, the devices upstream of the static eliminator 300 can be collectively interpreted as image forming apparatus.

### Image Forming Apparatus

The configuration of the image forming apparatus 100 will be described with reference to FIG. 1. The image forming apparatus 100 includes an image forming section 101 that is an intermediate transfer electrophotographic mechanism. The image forming section 101 includes four process units 11Y, 11M, 11C, 11K respectively having photoconductor drums 1Y, 1M, 1C, 1K, and a transfer unit 15 having an intermediate transfer belt 6 and a secondary transfer roller 9.

Each process unit includes a photoconductor drum as an image carrier (latent image carrier) and a charging device, an exposure device, and a developing device as a process section that acts on the photoconductor drum to perform the steps of an electrophotographic process. In other words, the process unit 11Y includes the photoconductor drum 1Y, the charging device 2Y, the exposure device 3Y, and the developing device 4Y. The process unit 11M includes the photoconductor drum 1M, the charging device 2M, the exposure device 3M, and the developing device 4M. The process unit 11C includes the photoconductor drum 1C, the charging device 2C, the exposure device 3C, and the developing device 4C. The process unit 11K includes the photoconductor drum 1K, the charging device 2K, the exposure device 3K, and the developing device 4K.

Each of the photoconductor drums 1Y, 1M, 1C, 1K is driven to rotate in a predetermined rotation direction A. The process units 11Y, 11M, 11C, 11K have substantially the same configuration except that toner used as a developer contained in a corresponding one of the developing devices 4Y, 4M, 4C, 4K is different.

The transfer unit 15 includes the intermediate transfer belt 6 as an intermediate transfer member, the secondary transfer roller 9 as a transfer device (secondary transfer device), primary transfer rollers 5Y, 5M, 5C, 5K, multiple rollers 20, 21, 22, 23, 24, 25, and a belt cleaner 12. The intermediate transfer belt 6 is stretched among the multiple rollers 20, 21, 22, 23, 24, 25. The primary transfer rollers 5Y, 5M, 5C, 5K are disposed on the inner surface side of the intermediate transfer belt 6 at positions respectively corresponding to the photoconductor drums 1Y, 1M, 1C, 1K. A primary transfer portion is formed between each of the primary transfer rollers 5Y, 5M, 5C, 5K and a corresponding one of the photoconductor drums 1Y, 1M, 1C, 1K. A roller 20 is a tension roller that applies appropriate tension to the intermediate transfer belt 6. A roller 22 is a drive roller that is driven to rotate the intermediate transfer belt 6 in a predetermined rotation direction G. The secondary transfer roller 9 is disposed so as to contact with the outer surface of the intermediate transfer belt 6 and to sandwich the intermediate transfer belt 6 with an opposing roller 21 (secondary transfer opposing roller). A secondary transfer portion T2 is formed as a transfer portion where a toner image is transferred to a sheet S, and serves as a nip portion between the secondary transfer roller 9 and the intermediate transfer belt 6.

The image forming apparatus 100 includes a transfer power supply 10 as a voltage application unit to form a bias electric field for transferring a toner image to the secondary transfer portion T2. In the present embodiment, the secondary transfer roller 9, which is the outer roller of the secondary transfer portion T2, is electrically connected to the transfer power supply 10, and a predetermined transfer voltage is applied from the transfer power supply 10 to the secondary transfer roller 9. The transfer voltage is a voltage of an opposite-polarity to the normal charge polarity of toner used for image formation. On the other hand, the opposing roller 21, which is the inner roller of the secondary transfer portion T2, is electrically connected to a ground potential (such as a metal frame) of the image forming apparatus 100.

The inner roller of the secondary transfer portion T2 may be connected to the transfer power supply 10, and the outer roller of the secondary transfer portion T2 may be connected to a ground potential GND. In this case, a transfer voltage of the same polarity as the normal charge polarity of toner is applied to the inner roller.

The image forming apparatus 100 further includes a storage section 63 (a storage or a cassette) that stores sheets S, a feeding unit 64 that feeds sheets S, registration rollers 8 that perform registration (alignment) of sheets S. The image forming apparatus 100 includes a pre-fixing conveying device 41 that conveys a sheet S having passed through the secondary transfer portion T2, a fixing device 40 that fixes a toner image onto a sheet S, and a discharge roller pair 42 as a discharge unit that discharges a sheet S to the outside of the image forming apparatus 100.

The feeding unit 64 includes, for example, a pick-up roller 65 that feeds out an uppermost sheet S from the storage section 63 in a sheet feeding direction, and a separation roller pair 66 that conveys the fed-out sheet S while separating the sheet S one by one. The separation roller pair 66 includes a conveying roller that feeds an uppermost sheet S in the sheet feeding direction, and a separation roller that contacts with the conveying roller to form a separation nip with the conveying roller. The separation roller reduces the double feeding of sheets S by applying frictional force to a sheet S at the separation nip to block passage of sheets S other than the uppermost sheet S through the separation nip. The separation roller is an example of a separation member that separates a sheet S, and, for example, a pad-shaped elastic member (rubber pad) may be used as the separation member.

The fixing device 40 is a heat fixing device that has a fixing nip and that heats a toner image on a sheet S while conveying the sheet S with the fixing nip. The fixing device 40 includes a heating member that contacts with the surface of a sheet S where a toner image is formed, a pressing member that forms a fixing nip with the heating member, and a heat source that heats the heating member. For example, a belt member stretched among a plurality of rollers or a roller member having rigidity can be used as the heating member and the pressing member. For example, a halogen lamp or an IH induction heating mechanism can be used as the heat source.

The image forming apparatus 100 includes an operating panel 102 (operating unit) that is the user interface of the image forming system 400. The operating panel 102 includes a display unit 103 that is a resistive film type touch panel that displays information to a user and accepts user's operations. The user is able to display setting information and set conditions for performing an image forming operation to the image forming system 400 by operating the operating panel 102. The setting information is attribute information, such as the size, material, and brand of sheets S stored in the storage section 63. The conditions for performing an image forming operation include, for example, the value of the transfer voltage.

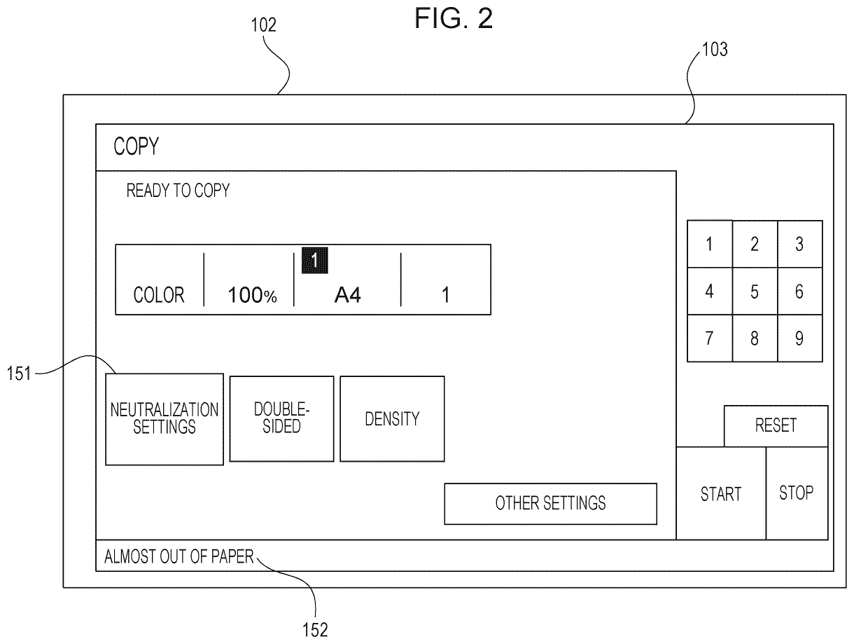

FIG. 2 shows a copy settings screen displayed on the display unit 103 of the operating panel 102. When the user performs setting related to neutralization using the static eliminator 300, the user presses a neutralization setting button 151.

When the neutralization setting button 151 is pressed, the display unit 103 transitions from the copy settings screen to a neutralization settings screen (described later). A status line 152 where a message related to information to be notified to the user is displayed on the display unit 103. The status line 152 is a region where the content of the display is held and continues to be displayed even when the display screen transitions. In the example of FIG. 2, to notify the user that the paper in the storage section 63 is running low, the message “Paper is running low.” is displayed. The user is able to understand the status of the image forming system 400 by checking the status line 152.

When instructions to perform image formation are input from the user, a control unit of the image forming apparatus 100 starts an image formation job that is a series of tasks to form images while conveying sheets S one by one and outputs products. Hereinafter, a series of operations in which an image is formed on a single sheet S by the image forming apparatus 100 is referred to as image forming operation. The image forming job includes an image forming operation to at least one sheet S.

In the image forming operation, toner images of respective colors are created in the process units 11Y, 11M, 11C, 11K. Specifically, the photoconductor drums 1Y, 1M, 1C, 1K are driven to rotate, and the charging devices 2Y, 2M, 2C, 2K respectively electrostatically charge the surfaces of the photoconductor drums 1Y, 1M, 1C, 1K uniformly. The exposure devices 3Y, 3M, 3C, 3K expose the photoconductor drums 1Y, 1M, 1C, 1K based on image information input along with the instructions, to respectively form electrostatic latent images on the surfaces of the photoconductor drums 1Y, 1M, 1C, 1K. The developing devices 4Y, 4M, 4C, 4K respectively supply yellow toner, magenta toner, cyan toner, and black toner to the photoconductor drums 1Y, 1M, 1C, 1K, and develop the electrostatic latent images into toner images of the respective colors.

In the present embodiment, a reversal developing method is used. In other words, after the charging device charges the surface of the photoconductor drum to the same polarity as the normal charge polarity of toner, the potential of the exposure region having been exposed by the exposure device attenuates, and toner adheres to the exposure region during developing.

The toner images created in the process units 11Y, 11M, 11C, 11K are primarily transferred from the photoconductor drums 1Y, 1M, 1C, 1K to the intermediate transfer belt 6 at the primary transfer portions. A transfer voltage of an opposite-polarity to the normal charge polarity of toner is applied to the primary transfer rollers 5Y, 5M, 5C, 5K through constant voltage control.

In the present embodiment, the primary transfer rollers 5Y, 5M, 5C, 5K each are a conductive roller that includes a core metal and an electrically conductive elastic layer formed on the outer peripheral side of the core metal. The elastic layer is made of, for example, ion-conductive foamed rubber. The ion-conductive foamed rubber is a foamed rubber material in which a conductive agent that exhibits ion conductivity is dispersed. Known materials can be used as the conductive agent and the foamed rubber material for the transfer rollers. Each primary transfer roller can have, for example, an outside diameter of 15 mm to 20 mm and a resistance value of 1E+5 Ω to 1E+8 Ω when a voltage of 2 kV is applied under environmental conditions of 23° C. and 50% RH.

The intermediate transfer belt 6 is driven to rotate at a predetermined peripheral speed (process speed) that is equal to the peripheral speeds of the photoconductor drums 1Y, 1M, 1C, 1K. The peripheral speed in the present embodiment ranges from 150 mm/sec to 470 mm/sec. As the intermediate transfer belt 6 rotates, toner images of other colors are transferred over toner images transferred at the primary transfer portions on the upstream side, with the result that a full-color toner image is formed on the intermediate transfer belt 6. A full-color toner image is carried on the intermediate transfer belt 6 and conveyed toward the secondary transfer portion T2.

While the toner image is being created in the image forming section 101, the feeding unit 64 feeds a sheet S one by one toward the image forming section 101. The fed sheet S is conveyed to the secondary transfer portion T2 by the registration rollers 8 in synchronization with the timing at which the toner image on the intermediate transfer belt 6 is conveyed to the secondary transfer portion T2. Then, at the secondary transfer portion T2, the toner image is transferred (secondary transfer) from the intermediate transfer belt 6 to the sheet S.

In the present embodiment, the secondary transfer roller 9 is a conductive roller that includes a core metal and an electrically conductive elastic layer formed on the outer peripheral side of the core metal. The elastic layer is made of, for example, ion-conductive foamed rubber. The ion-conductive foamed rubber is a foamed rubber material in which a conductive agent that exhibits ion conductivity is dispersed. Known materials can be used as the conductive agent and the foamed rubber material for the transfer roller. The secondary transfer roller 9 can have, for example, an outside diameter of 20 mm to 25 mm and a resistance value of 1E+5 Ω to 1E+8 Ω when a voltage of 2 kV is applied under environmental conditions of 23° C. and 50% RH.

The opposing roller 21 is a conductive rubber roller that includes a core metal and an elastic layer of electron conductive foamed rubber, formed on the outer peripheral side of the core metal. The electron conductive foamed rubber is a foamed rubber material in which a conductive agent that exhibits electron conductivity is dispersed. Known materials can be used as the conductive agent and the foamed rubber material for the transfer roller. The opposing roller 21 can have, for example, an outside diameter of 20 mm to 22 mm and a resistance value of 1E+5 Ω to 1E+8 Ω when a voltage of 50 V is applied under environmental conditions of 23° C. and 50% RH.

During secondary transfer, a transfer voltage of an opposite-polarity to the normal charge polarity of toner is applied from the transfer power supply 10 to the secondary transfer roller 9 through constant voltage control. The transfer voltage, for example, ranges from +1 kV to +7 kV and is automatically adjusted such that a current of +40 μA to +120 μA flows from the secondary transfer roller 9 to the opposing roller 21. By applying the transfer voltage, a bias electric field where the potential of the secondary transfer roller 9 has an opposite-polarity to the normal charge polarity of toner with respect to the intermediate transfer belt 6 is formed at the secondary transfer portion T2. The electrostatic force in the direction toward the secondary transfer roller 9 acts on toner on the intermediate transfer belt 6 due to this bias electric field. Then, the toner is transferred from the intermediate transfer belt 6 to a sheet S passing through the secondary transfer portion T2, with the result that a toner image is transferred to the sheet S.

A conveying guide 11 is provided just before the secondary transfer portion T2 to improve the positional accuracy of a sheet S on the intermediate transfer belt 6. The residual toner not transferred to the sheet S and remaining on the intermediate transfer belt 6 is collected by the belt cleaner 12 and reused in image formation.

The sheet S having passed through the secondary transfer portion T2 is conveyed by the pre-fixing conveying device 41 to the fixing device 40 to undergo a toner image fixing process by the fixing device 40. The fixing process is a process of heating and pressurizing a toner image on a sheet S while conveying the sheet S with the sheet S being held at the nip portion of the fixing device 40. The pre-fixing conveying device 41 conveys the sheet S while carrying the sheet S on, for example, an endless rubber belt. An ethylene propylene diene monomer (EPDM) with a width of 100 mm to 110 mm and a thickness of 1 mm to 3 mm can be used as the rubber belt. The rubber belt has holes with a diameter of 3 mm to 7 mm. By using a fan to generate negative pressure inside the rubber belt, it is possible to stably carry the sheet S on the rubber belt.

The sheet S having passed through the fixing device 40 is discharged toward the static eliminator 300 by the discharge roller pair 42.

The intermediate transfer image forming section 101 is an example of the image forming section that forms images on sheets S. The image forming section may be, for example, a direct transfer electrophotographic unit. In this case, the toner image formed on the photoconductor drum as the image carrier is directly transferred from the photoconductor drum to the sheet S at the transfer nip (transfer portion) where the photoconductor drum and the transfer roller face each other.

A bias electric field where the potential of the transfer roller has an opposite-polarity to the normal charge polarity of toner with respect to the photoconductor drum is formed at the transfer nip.

### Static Eliminator

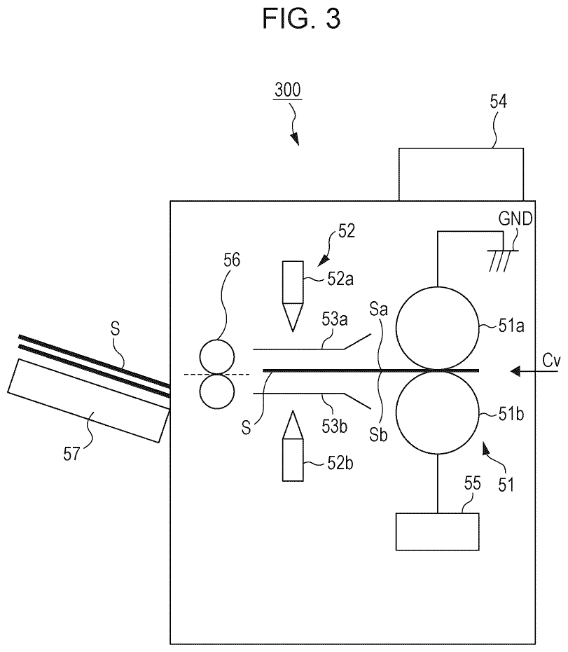

FIG. 3 is a schematic diagram of the static eliminator 300 in the present embodiment. The static eliminator 300 includes a charge eliminating roller pair 51 as a contact charge removing device, an ionizer unit 52 as a noncontact charge removing device, and a high-voltage circuit board 55 (high-voltage power supply).

The charge eliminating roller pair 51 includes a charge eliminating opposing roller 51a that contacts with the first surface Sa of a sheet S and a charge eliminating roller 51b that contacts with the second surface Sb of the sheet S, which is opposite to the first surface Sa. The charge eliminating roller 51b is a contact charge eliminating component that contacts with a conveyed sheet S to neutralize the sheet S. The charge eliminating opposing roller 51a contacts with the charge eliminating roller 51b to form a neutralization nip as a nip portion between the charge eliminating roller 51b and the charge eliminating opposing roller 51a. The charge eliminating roller pair 51 neutralizes the sheet S while conveying the sheet S in the sheet conveyance direction Cv with the sheet S being held at the neutralization nip.

The charge eliminating opposing roller 51a is connected to the ground potential GND. The charge eliminating opposing roller 51a is electrically connected to, for example, the metal frame of the static eliminator 300. The charge eliminating roller 51b is connected to the high-voltage circuit board 55. The high-voltage circuit board 55 is a voltage application unit that applies a voltage (neutralizing voltage) for neutralizing the sheet S to the charge eliminating roller 51b.

The charge eliminating roller 51b may be disposed so as to contact with the first surface Sa of the sheet S, and the charge eliminating opposing roller 51a may be disposed so as to contact with the second surface Sb of the sheet S. In this case, the voltage applied to the charge eliminating roller 51b has an opposite-polarity to the voltage applied to the charge eliminating roller 51b in the present embodiment.

In the present embodiment, the charge eliminating roller 51b is a conductive roller that includes a core metal and an electrically conductive elastic layer formed on the outer peripheral side of the core metal. The elastic layer is made of, for example, ion-conductive foamed rubber. The ion-conductive foamed rubber is a foamed rubber material in which a conductive agent that exhibits ion conductivity is dispersed. Known materials can be used as the conductive agent and the foamed rubber material. The charge eliminating roller 51b can have, for example, an outside diameter of 20 mm to 25 mm and a resistance value of 1E+5 Ω to 1E+8 Ω when a voltage of 2 kV is applied under environmental conditions of 23° C. and 50% RH. The charge eliminating opposing roller 51a is made of stainless steel (SUS) and is a roller with an outside diameter of 20 mm to 25 mm. A roller made of a metal material, such as stainless steel, may be used as the charge eliminating roller 51b.

The ionizer unit 52 includes a first ionizer 52a facing the first surface Sa of a sheet S and a second ionizer 52b facing the second surface Sb of the sheet S. The ionizer unit 52 is a noncontact neutralizing portion disposed downstream of the charge eliminating roller pair 51 in the sheet conveyance direction Cv. Each of the first ionizer 52a and the second ionizer 52b has an electrode needle. Applying voltage to the electrode needles causes corona discharge from the needle tips to ionize air around the tips. Then, the produced ions neutralize the electric charge on the front surface of a sheet S to remove the electric charge of the sheet S.

In the present embodiment, the ionizer unit 52 is configured such that the first ionizer 52a and the second ionizer 52b are disposed above and below the sheet conveying path. Conveying guides 53a, 53b that form the sheet conveying path of the ionizer unit 52 are made of, for example, a synthetic resin of polycarbonate (PC) and acrylonitrile-butadiene-styrene (ABS). The volume resistivity of the conveying guides 53a, 53b is, for example, 1×10¹⁴ Ω·cm. Furthermore, as shown in FIG. 3, each of the conveying guides 53a, 53b has multiple holes for ions emitted from the first ionizer 52a and the second ionizer 52b not to be physically shielded.

The first ionizer 52a and the second ionizer 52b are examples of the noncontact charge removing device, and other noncontact charge removing devices may also be used. For example, a corotron-type or scorotron-type charge removing device that neutralizes a sheet using corona discharge from a discharging wire may be used. The noncontact charge removing device does not necessarily need to be provided on both sides of the conveying path. For example, the static eliminator 300 may include only the first ionizer 52a as a noncontact charge removing device. When the charge eliminating roller 51b can sufficiently neutralize sheets S, the noncontact charge removing device may be omitted.

A major part of electric charge of the sheet S conveyed from the image forming apparatus 100 to the static eliminator 300 is initially removed (roughly removed) at the neutralization nip of the charge eliminating roller pair 51. Specifically, a neutralizing voltage is set to have an opposite-polarity to the transfer voltage applied to the secondary transfer roller 9. The value of the neutralizing voltage is set in the range of −1 kV to −6 kV.

Immediately after passing through the secondary transfer portion T2 (FIG. 1), commonly, the first surface Sa of the sheet S, which has been in contact with the intermediate transfer belt 6, is negatively charged, and the second surface Sb, which has been in contact with the secondary transfer roller 9, is positively charged. When a neutralizing voltage of an opposite-polarity to the transfer voltage is applied to the charge eliminating roller 51b, a current flows between the charge eliminating roller 51b and the charge eliminating opposing roller 51a such that positive electric charge is supplied to the first surface Sa of the sheet S and negative electric charge is supplied to the second surface Sb. In this way, when a neutralizing voltage is applied to the charge eliminating roller 51b, a current flows through the sheet S at the neutralization nip, with the result that the amount of electric charge on the sheet S, which is the amount of electric charge carried on the first surface Sa and second surface Sb of the sheet S, is reduced.

The sheet S having passed through the charge eliminating roller pair 51 is further neutralized at the ionizer unit 52.

Specifically, electric charge remaining on the first surface Sa and second surface Sb of the sheet S are neutralized by ions emitted from the first ionizer 52a and the second ionizer 52b, and the amount of electric charge on the sheet S is further reduced. The sheet S having passed through the ionizer unit 52 is discharged to the outside of the static eliminator 300 by the discharge roller pair 56 and is stacked on a discharge tray 57. Neutralization Settings Using Operating Unit of Static Eliminator

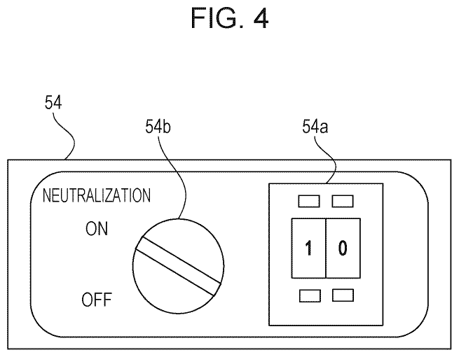

The static eliminator 300 includes an operating unit 54 for setting the magnitude of voltage applied to the charge eliminating roller 51b. FIG. 4 shows the operating unit 54. The operating unit 54 includes a thumbwheel switch 54a and a selector switch 54b that are hardware keys. Hereinafter, settings related to neutralization, such as the neutralization level indicating the value of voltage applied to the charge eliminating roller 51b by the high-voltage circuit board 55 and the on/off setting for applying voltage to the charge eliminating roller 51b, are referred to as “neutralization settings”. The hardware keys are physical members that are operated by the user. In other words, the thumbwheel switch 54a and the selector switch 54b are physical controls that are physically pressed or turned by the user.

The thumbwheel switch 54a is a switch used to manually set the value of voltage applied to the charge eliminating roller 51b by the high-voltage circuit board 55. The thumbwheel switch 54a displays a neutralization level that is a numeric value corresponding to the voltage applied to the charge eliminating roller 51b. As the neutralization level increases, the voltage applied to the charge eliminating roller 51b increases. The user is able to change the neutralization level by operating the thumbwheel switch 54a. The thumbwheel switch 54a is an example of a first setting unit disposed in the static eliminator 300 and used to set the neutralizing voltage.

The selector switch 54b is a switch for manually switching between the “ON” and “OFF” of voltage applied to the charge eliminating roller 51b. When the selector switch 54b is “ON”, the voltage corresponding to the set neutralization level is applied to the charge eliminating roller 51b. When the selector switch 54b is “OFF,” no voltage is applied to the charge eliminating roller 51b. The user is able to switch the on or off state of neutralization without changing the settings (neutralization level) of the thumbwheel switch 54a by operating the selector switch 54b. The selector switch 54b is an example of a fourth setting unit used to switch the on or off state of neutralization.

In the present embodiment, when the selector switch 54b is set to “OFF”, no voltage is applied to the charge eliminating roller 51b; however, voltage is applied to the first ionizer 52a and the second ionizer 52b. For example, even when sheets do not need neutralization by the charge eliminating roller pair 51, the sheets may be slightly charged due to the friction of the conveying guides. In such cases, by neutralizing the sheets with the first ionizer 52a and the second ionizer 52b, it is possible to suppress the repulsion between the discharged sheets and improve the loading property of the sheets.

The operating unit 54 does not need to include the selector switch 54b. With this configuration, application of voltage to the charge eliminating roller 51b can be set to “OFF”by setting the neutralization level to “00” using the thumbwheel switch 54a.

### Neutralization Setting Using Operating Unit of Image Forming Apparatus

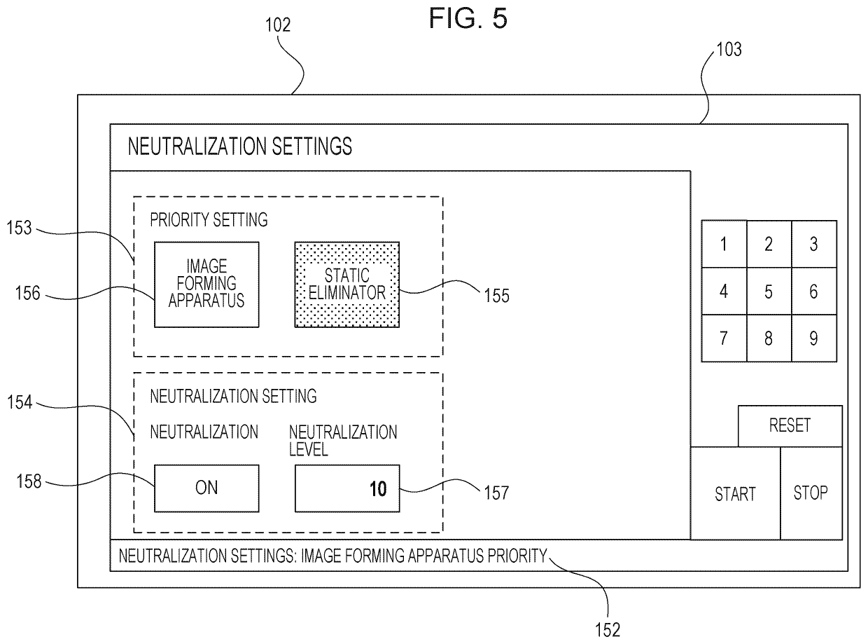

In the present embodiment, various settings related to a print job can be made via the operating panel 102 of the image forming apparatus 100. Therefore, the magnitude of voltage applied to the charge eliminating roller 51b can be set via the operating panel 102 of the image forming apparatus 100. FIG. 5 shows a neutralization settings screen displayed on the display unit 103 of the operating panel 102. When the neutralization setting button 151 of FIG. 2 is pressed, the screen of the display unit 103 transitions from the copy settings screen to the neutralization settings screen.

The neutralization settings screen displays a mode setting section 153 and a voltage setting section 154. The voltage setting section 154 contains a neutralization level button 157 and an ON/OFF button 158 that are software keys. The neutralization level button 157 is a button for setting the value of voltage applied to the charge eliminating roller 51b by the high-voltage circuit board 55. The neutralization level button 157 displays a neutralization level that is a numeric value corresponding to the voltage applied to the charge eliminating roller 51b. The user is able to press the neutralization level button 157 and then set a neutralization level to a selected value using a numeric keypad. The user is able to change the neutralization level by operating the neutralization level button 157. In other words, the neutralization level button 157 has a similar function to the thumbwheel switch 54a. The neutralization level button 157 is an example of a second setting unit provided in the image forming apparatus 100 and used to set a neutralizing voltage.

The ON/OFF button 158 is a button for manually switching between the “ON” and “OFF” of voltage applied to the charge eliminating roller 51b. The user is able to switch the on or off state of neutralization by operating the ON/OFF button 158 without changing the settings of the neutralization level button 157. In other words, the ON/OFF button 158 has a similar function to the selector switch 54b. The ON/OFF button 158 is an example of the fourth setting unit used to switch the on or off state of neutralization.

The mode setting section 153 is used to select which neutralization settings are applied (reflected) to the neutralization operation, the neutralization settings via the operating unit 54 (thumbwheel switch 54a) of the static eliminator 300 or the neutralization settings via the operating panel 102 (voltage setting section 154) of the image forming apparatus 100. The mode setting section 153 displays the static eliminator button 155 and the image forming apparatus button 156 in a state where any one of the static eliminator button 155 and the image forming apparatus button 156 is selected.

In the present embodiment, the button selected in the mode setting section 153 is displayed brightly, while the button that is not selected is displayed to be grayed out. In the example of FIG. 5, since the image forming apparatus button 156 is selected, the static eliminator button 155 is grayed out. The mode setting section 153 is an example of a third setting unit used to set a first mode to apply the value of the thumbwheel switch 54a or a second mode to apply the value of the neutralization level button 157, as the value of voltage applied to the charge eliminating roller 51b.

When the static eliminator button 155 is selected, neutralization settings via the operating unit 54 of the static eliminator 300 are applied to the neutralization operation. In other words, the voltage corresponding to the neutralization level set by the thumbwheel switch 54a is applied to the charge eliminating roller 51b, and, when the selector switch 54b is set to “OFF”, no voltage is applied to the charge eliminating roller 51b. Then, when the static eliminator button 155 is selected, the neutralization settings via the operating panel 102 of the image forming apparatus 100 are not applied; however, the setting information of the voltage setting section 154 is held.

On the other hand, when the image forming apparatus button 156 is selected, neutralization settings via the operating panel 102 of the image forming apparatus 100 are applied to the neutralization operation. In other words, the voltage corresponding to the neutralization level set by the neutralization level button 157 is applied to the charge eliminating roller 51b, and, when the ON/OFF button 158 is set to “OFF”, no voltage is applied to the charge eliminating roller 51b. When the image forming apparatus button 156 is selected, the neutralization settings via the operating unit 54 of the static eliminator 300 are not applied.

In this way, the user is able to select, using the mode setting section 153, which neutralization settings are applied to the neutralization operation, the neutralization settings via the operating unit 54 of the static eliminator 300 or the neutralization settings via the operating panel 102 of the image forming apparatus 100. In other words, it is possible to select, using the mode setting section 153, the first mode in which the neutralization settings via the operating unit 54 of the static eliminator 300 are applied or the second mode in which the neutralization settings via the operating panel 102 of the image forming apparatus 100 are applied.

The status line 152 displays the setting of the mode setting section 153. In the example of FIG. 5, the image forming apparatus button 156 is selected, so the message “NEUTRALIZATION SETTINGS: PRIORITY ON IMAGE FORMING APPARATUS” is displayed.

### System Control Configuration

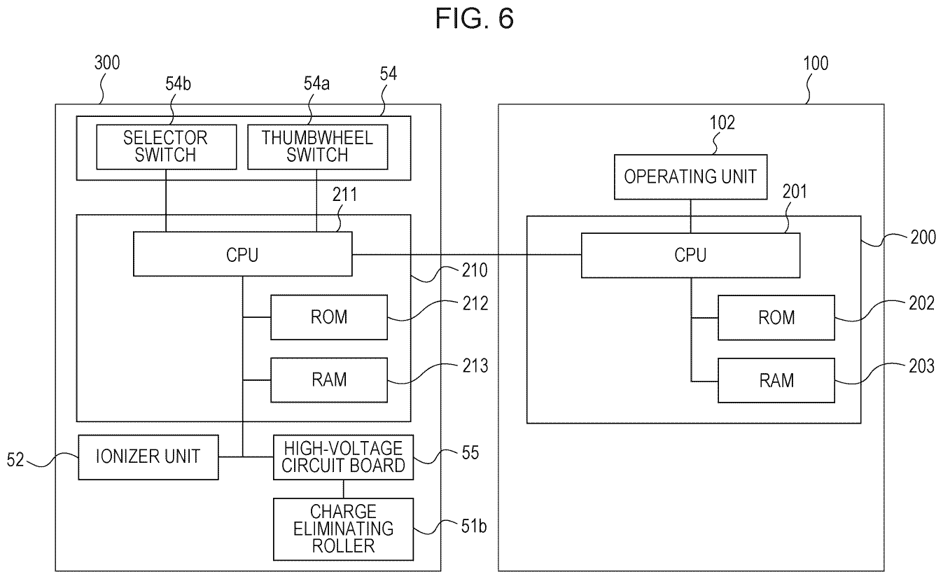

FIG. 6 is a block diagram that shows the control configuration of the image forming system 400 made up of the image forming apparatus 100 and the static eliminator 300. The image forming apparatus 100 includes an image forming control unit 200 for controlling the image forming operation. The image forming control unit 200, which is a control unit, includes a CPU 201, a ROM 202, and a RAM 203. The CPU 201 is an execution unit that reads and runs a control program. The RAM 203 serves as a working space when the CPU 201 runs the control program. The ROM 202 is an example of a storage unit that stores various pieces of information, such as setting information related to the control of the image forming apparatus 100. The operating panel 102 is connected to the CPU 201, and the CPU 201 is capable of controlling a screen displayed on the display unit 103.

The static eliminator 300 includes a neutralization control unit 210 that controls the neutralization operation. The neutralization control unit 210 includes a CPU 211, a ROM 212, and a RAM 213. The CPU 211 is an execution unit that reads and runs a control program. The RAM 213 serves as a working space when the CPU 211 runs the control program. The ROM 212 is an example of a storage unit that stores various pieces of information, such as setting information related to the control of the static eliminator 300. The CPU 211 of the neutralization control unit 210 is connected to the CPU 201 of the image forming control unit 200 by a communication cable, and is capable of operating in coordination as the image forming system 400 through bidirectional communication.

The operating unit 54 (the thumbwheel switch 54a and the selector switch 54b), the high-voltage circuit board 55, and the ionizer unit 52 are connected to the CPU 211. The CPU 211 controls the high-voltage circuit board 55 based on the settings via the operating unit 54 of the static eliminator 300 or the operating panel 102 of the image forming apparatus 100. At this time, the CPU 201 determines which neutralization settings are applied to the neutralization operation, the neutralization settings via the operating unit 54 of the static eliminator 300 or the neutralization settings via the operating panel 102 of the image forming apparatus 100, based on the mode setting section 153.

### Flowchart

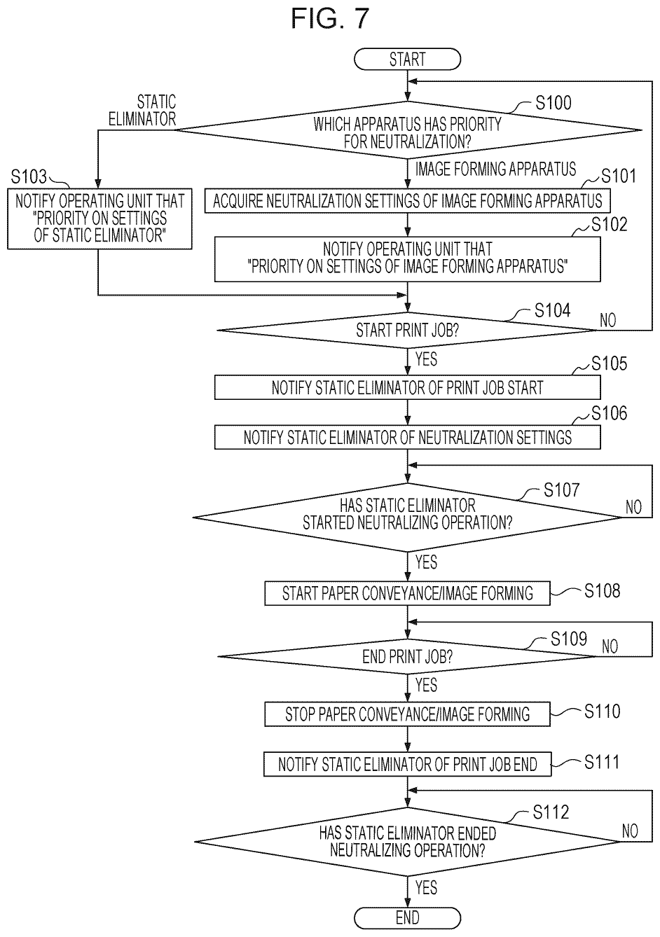

Next, the process of a print job will be described. FIG. 7 is a flowchart that shows the process that is executed by the CPU 201 of the image forming apparatus 100.

First, the CPU 201 checks which neutralization settings have currently priority, the neutralization settings of the image forming apparatus 100 or the neutralization settings of the static eliminator 300 (S100). In other words, the CPU 201 determines which neutralization settings are applied to the neutralization operation, the neutralization settings via the operating unit 54 of the static eliminator 300 or the neutralization settings via the operating panel 102 of the image forming apparatus 100. This determination is performed based on the setting in the mode setting section 153.

When the neutralization settings via the operating panel 102 of the image forming apparatus 100 have priority (the image forming apparatus in S100), the CPU 201 acquires the neutralization settings set via the operating panel 102 of the image forming apparatus 100 (S101). After that, the CPU 201 causes the status line 152 of the display unit 103 to display that “PRIORITY ON SETTINGS OF IMAGE FORMING APPARATUS” (S102). On the other hand, when the neutralization settings via the operating unit 54 of the static eliminator 300 have priority (the static eliminator in S100), the CPU 201 causes the status line 152 of the display unit 103 to display that “PRIORITY ON SETTINGS OF STATIC ELIMINATOR” (S103).

Next, the CPU 201 determines whether the print job has been started (S104). When the print job has not been started (NO in S104), the CPU 201 continues to monitor whether the neutralization settings are changed (S100). When the print job has been started (YES in S104), the CPU 201 notifies the static eliminator 300 of the start of the print job (S105) and notifies the CPU 211 of the neutralization settings (S106). More specifically, when the neutralization settings via the operating panel 102 of the image forming apparatus 100 have priority, the neutralization level of the neutralization level button 157 and the setting status of the ON/OFF button 158 are notified to the CPU 211. When the neutralization settings via the operating unit 54 of the static eliminator 300 have priority, this information is notified to the CPU 211. Based on the details of notification here, the static eliminator 300 operates. The flowchart of the process that is executed by the CPU 211 of the static eliminator 300 will be described later.

The CPU 201 determines whether the static eliminator 300 has started the neutralization operation (S107). When the static eliminator 300 has started the neutralization operation (YES in S107), the image forming apparatus 100 starts sheet conveyance and image formation operation (S108). The image forming apparatus 100 operates until the print job ends (S109), and, when the print job ends (YES in S109), the image forming apparatus 100 ends sheet conveyance and image formation operation (S110). Then, the CPU 201 notifies the static eliminator 300 of the end of the print job (S111). Then, the CPU 201 determines whether the static eliminator 300 has ended the neutralization operation (S112), and, after confirming the end of the neutralization operation (YES in S112), ends the process of the flowchart.

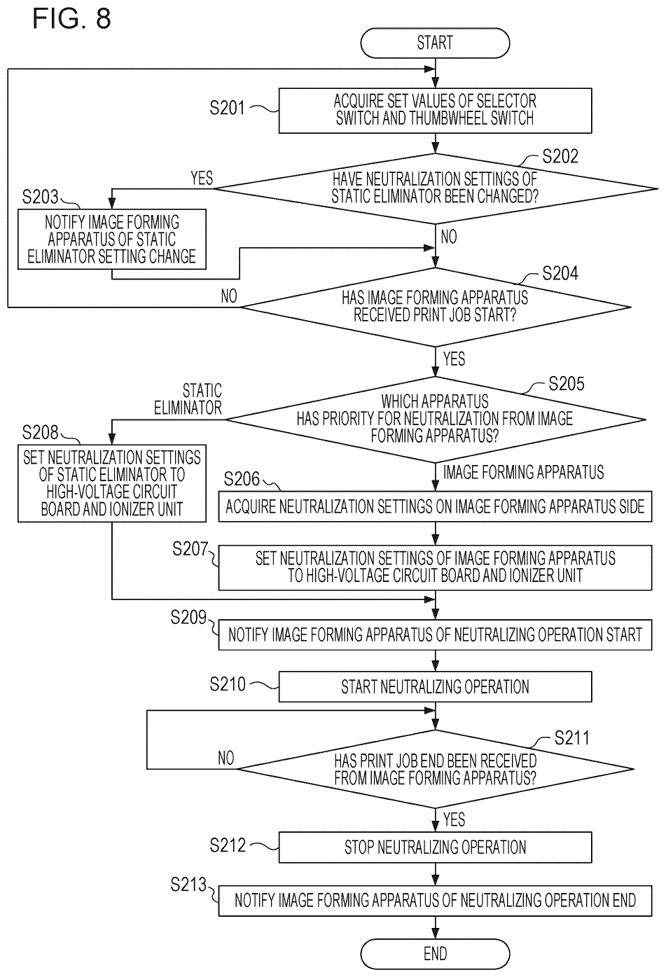

Next, the process that is executed by the CPU 211 of the static eliminator 300 in the print job will be described. FIG. 8 is a flowchart that shows a process executed by the CPU 211 of the static eliminator 300.

The CPU 211 initially acquires the setting values of the thumbwheel switch 54a and the selector switch 54b (S201). The CPU 211 determines whether the neutralization settings of the static eliminator 300 have been changed (S202), and, when the neutralization settings have been changed (YES in S202), the CPU 211 notifies the image forming apparatus 100 of the changes of the neutralization settings (S203). When the neutralization settings have not been changed (NO in S202), the CPU 211 proceeds to the next process. The CPU 211 determines whether a notification about the start of the print job has received from the image forming apparatus 100 (S204), and, when the start of the print job has not been received (NO in S204), the CPU 211 continues to monitor whether the neutralization settings have been changed (S201).

When the CPU 211 receives the start of the print job (YES in S204), the CPU 211 determines which neutralization settings have priority, the neutralization settings via the static eliminator 300 or the neutralization settings via the image forming apparatus 100 (S205). In other words, the CPU 211 determines which neutralization settings are applied to the neutralization operation, the neutralization settings via the operating unit 54 of the static eliminator 300 or the neutralization settings via the operating panel 102 of the image forming apparatus 100. This determination is based on the notification from the CPU 201 in S106.

When the image forming apparatus 100 has priority (the image forming apparatus in S205), the CPU 211 acquires the neutralization settings set via the operating panel 102 of the image forming apparatus 100 (S206) and sets the neutralization settings to the high-voltage circuit board 55 and the ionizer unit 52 (S207). When the static eliminator 300 has priority (the static eliminator in S205), the CPU 211 sets the values acquired from the thumbwheel switch 54a and the selector switch 54b to the high-voltage circuit board 55 and the ionizer unit 52 (S208). Then, the CPU 211 notifies the image forming apparatus 100 of the start of the neutralization operation (S209) and starts the neutralization operation (S210). The static eliminator 300 continues the neutralization operation until the print job ends (NO in S211), and, when the CPU 211 receives the end of the print job (YES in S211), the CPU 211 stops the neutralization operation (S212). Then, the CPU 211 notifies the image forming apparatus 100 of the end of the neutralization operation (S213). In this way, the CPU 211 of the static eliminator 300 controls the neutralization operation in accordance with the operation instructions from the CPU 201 of the image forming apparatus 100.

Incidentally, in this present embodiment, it is possible to perform neutralization setting via both the operating unit 54 of the static eliminator 300 and the operating panel 102 of the image forming apparatus 100. Therefore, there may be a discrepancy between the neutralization settings via the operating unit 54 of the static eliminator 300 and the neutralization settings via the operating panel 102 of the image forming apparatus 100. For example, there may be cases where the neutralization level of the thumbwheel switch 54a is “10” and the neutralization level of the neutralization level button 157 is “15”.

In another example, there are cases where the selector switch 54b is “OFF” and the ON/OFF button 158 is “ON”. In this way, discrepancies in neutralization settings can lead to user confusion, which actually makes it difficult to set the voltage applied to the charge eliminating roller 51b.

Therefore, the neutralization settings screen in the present embodiment contains the mode setting section 153. With the mode setting section 153, the user is able to freely set which neutralization settings are applied, the neutralization settings via the operating unit 54 of the static eliminator 300 or the neutralization settings via the operating panel 102 of the image forming apparatus 100. As a result, it is possible to improve usability when the user performs neutralization setting.

The details set in the mode setting section 153 are displayed on the status line 152. Specifically, the status line 152 displays whether the first mode to apply the value of the thumbwheel switch 54a or the second mode to apply the value of the neutralization level button 157 is set. The display on the status line 152 is held even when the display screen transitions from the neutralization settings screen to another screen. As a result, the user is able to check the setting of the mode setting section 153 at any time, so usability further improves.

### Modification

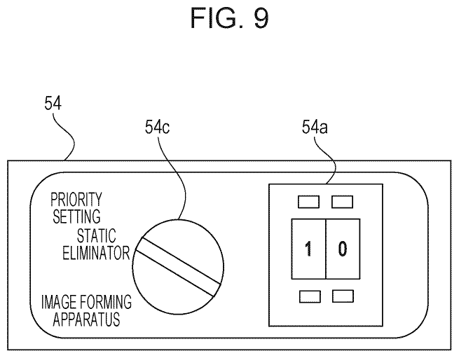

Next, a modification of the first embodiment will be described. FIG. 9 is a diagram that shows a modification of the operating unit 54 of the static eliminator 300. The operating unit 54 shown in FIG. 9 includes a mode switch 54c instead of the selector switch 54b.

The mode switch 54c is used to select which neutralization settings are applied to the neutralization operation, the neutralization settings via the operating unit 54 of the static eliminator 300 or the neutralization settings via the operating panel 102 of the image forming apparatus 100.

In other words, the mode switch 54c has a similar function to the mode setting section 153. The mode switch 54c is an example of the third setting unit used to set the first mode to apply the value of the thumbwheel switch 54a or the second mode to apply the value of the neutralization level button 157, as the value of voltage applied to the charge eliminating roller 51b.

When the “static eliminator” is selected in the mode switch 54c, the neutralization settings from the operating unit 54 of the static eliminator 300 are applied. In other words, the voltage corresponding to the neutralization level set by the thumbwheel switch 54a is applied to the charge eliminating roller 51b, and, when the selector switch 54b is set to “OFF”, no voltage is applied to the charge eliminating roller 51b. Then, when the “static eliminator” is selected in the mode switch 54c, the neutralization settings via the operating panel 102 of the image forming apparatus 100 are not applied.

On the other hand, when the “image forming apparatus” is selected in the mode switch 54c, the neutralization settings via the operating panel 102 of the image forming apparatus 100 are applied. In other words, the voltage corresponding to the neutralization level set by the neutralization level button 157 is applied to the charge eliminating roller 51b, and, when the ON/OFF button 158 is set to “OFF,” no voltage is applied to the charge eliminating roller 51b. Then, when the “image forming apparatus” is selected in the mode switch 54c, the neutralization settings via the operating unit 54 of the static eliminator 300 are not applied.

In this way, the user is able to select, using the mode switch 54c, which neutralization settings are applied to the neutralization operation, the neutralization settings via the operating unit 54 of the static eliminator 300 or the neutralization settings via the operating panel 102 of the image forming apparatus 100. In other words, it is possible to select, using the mode switch 54c, the first mode in which the neutralization settings via the operating unit 54 of the static eliminator 300 are applied or the second mode in which the neutralization settings via the operating panel 102 of the image forming apparatus 100 are applied.

In such a modification as well, the user is able to freely set which neutralization settings are applied, the neutralization settings via the operating unit 54 of the static eliminator 300 or the neutralization settings via the operating panel 102 of the image forming apparatus 100. As a result, it is possible to improve usability when the user performs neutralization setting.

Furthermore, since the mode switch 54c is provided on the outer casing of the static eliminator 300, the user is able to easily check which neutralization settings have priority, the neutralization settings of the static eliminator 300 or the neutralization settings of the image forming apparatus 100. When the mode switch 54c is provided in the operating unit 54 of the static eliminator 300, the mode setting section 153 in the neutralization settings screen can be not provided (omitted) to reduce user confusion. In the first embodiment, any one of the image forming apparatus 100 and the static eliminator 300 just needs to include a device (third setting unit) used to switch between the first mode and the second mode.

### Second Embodiment

Next, the second embodiment of the present disclosure will be described. In the first embodiment, the example in which the mode setting section 153 used to select the first mode in which the neutralization settings via the operating unit 54 of the static eliminator 300 are applied or the second mode in which the neutralization settings via the operating panel 102 of the image forming apparatus 100 are applied is provided has been described. In addition, the example in which the mode switch 54c is provided on the operating unit 54 of the static eliminator 300 instead of the mode setting section 153 has been described.

On the other hand, in the second embodiment, an example in which the CPU 201 automatically switches between the first mode in which the neutralization settings via the operating unit 54 of the static eliminator 300 are applied and the second mode in which the neutralization settings via the operating panel 102 of the image forming apparatus 100 are applied will be described. In the second embodiment, the basic configuration of the image forming system 400 is similar to that of the first embodiment, so the description is omitted.

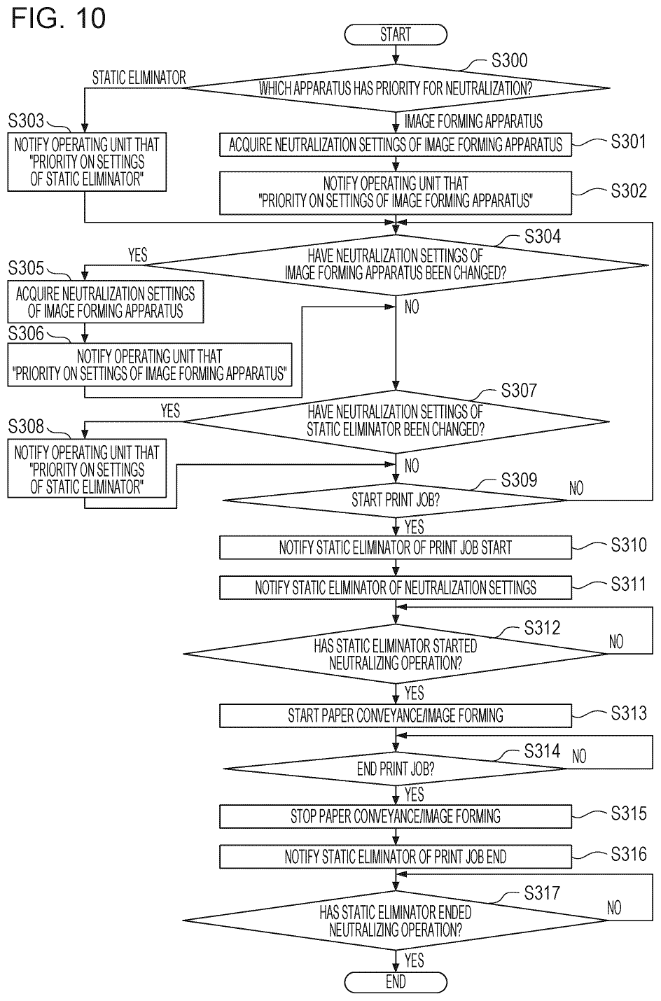

FIG. 10 is a flowchart that shows a process that is executed by the CPU 201 of the image forming apparatus 100 according to the second embodiment. The basic flow is similar to that of FIG. 7 in the first embodiment; however, the flow of automatically changing priority (S304 to S308) is added.

First, the CPU 201 checks which neutralization settings have currently priority, the neutralization settings of the image forming apparatus 100 or the neutralization settings of the static eliminator 300 (S300). In other words, the CPU 201 determines which neutralization settings are applied to the neutralization operation, the neutralization settings via the operating unit 54 of the static eliminator 300 or the neutralization settings via the operating panel 102 of the image forming apparatus 100. This determination is performed based on the setting in the mode setting section 153.

When the neutralization settings via the operating panel 102 of the image forming apparatus 100 have priority (the image forming apparatus in S300), the CPU 201 acquires the neutralization settings set via the operating panel 102 of the image forming apparatus 100 (S301). After that, the CPU 201 causes the status line 152 of the display unit 103 to display that “PRIORITY ON SETTINGS OF IMAGE FORMING APPARATUS” (S302). On the other hand, when the neutralization settings via the operating unit 54 of the static eliminator 300 have priority (the static eliminator in S300), the CPU 201 causes the status line 152 of the display unit 103 to display that “PRIORITY ON SETTINGS OF STATIC ELIMINATOR” (S303).

Subsequently, the CPU 201 monitors whether the neutralization settings have been changed on the operating panel 102 of the image forming apparatus 100 (S304). When the neutralization settings have been changed on the operating panel 102 of the image forming apparatus 100 (YES in S304), the CPU 201 acquires the neutralization settings of the image forming apparatus 100 (S305) and notifies the operating panel 102 that the settings of the image forming apparatus 100 have priority (S306). At this time, when the static eliminator button 155 is selected in the mode setting section 153, the image forming apparatus button 156 is selected.

When the neutralization settings have not been changed on the operating panel 102 of the image forming apparatus 100 (NO in S304), the CPU 201 monitors whether the neutralization settings have been changed on the operating unit 54 of the static eliminator 300 (S307). This can be checked using notification from the CPU 211 of the static eliminator 300. When the neutralization settings have been changed on the operating unit 54 of the static eliminator 300 (YES in S307), the CPU 201 notifies the operating panel 102 that the settings of the static eliminator 300 have priority (S308). At this time, when the image forming apparatus button 156 is selected in the mode setting section 153, the static eliminator button 155 is selected. When the neutralization settings have not been changed on the operating unit 54 of the static eliminator 300 (NO in S307), the CPU 201 proceeds to the next process.

Subsequently, the CPU 201 determines whether the print job has been started (S309). When the print job has not been started (NO in S309), the CPU 201 continues to monitor whether the neutralization settings have been changed (S304). When the print job has been started (YES in S309), the CPU 201 notifies the static eliminator 300 of the start of the print job (S310) and notifies the CPU 211 of the neutralization settings (S311).

The CPU 201 determines whether the static eliminator 300 has started the neutralization operation (S312). When the static eliminator 300 has started the neutralization operation (YES in S312), the image forming apparatus 100 starts sheet conveyance and image formation operation (S313). The image forming apparatus 100 operates until the print job ends (S314), and, when the print job ends (YES in S314), the image forming apparatus 100 ends sheet conveyance and image formation operation (S315). Then, the CPU 201 notifies the static eliminator 300 of the end of the print job (S316). Then, the CPU 201 determines whether the static eliminator 300 has ended the neutralization operation (S317), and, after confirming the end of the neutralization operation (YES in S317), ends the process of the flowchart.

In the flowchart described above, the CPU 201 switches from the first mode in which the neutralization settings via the operating unit 54 are applied to the second mode in which the neutralization settings via the operating panel 102 are applied, based on the changes of the neutralization settings via the operating panel 102. The CPU 201 switches from the second mode in which the neutralization settings via the operating panel 102 are applied to the first mode in which the neutralization settings via the operating unit 54 are applied, based on the changes of the neutralization settings via the operating unit 54. As a result, the user does not need to switch modes in the mode setting section 153, so operability improves. In the present embodiment, the CPU 201 functions as the third setting unit used to select the first mode or the second mode.

In the second embodiment as well, the user is able to set which neutralization settings are applied, the neutralization settings via the operating unit 54 of the static eliminator 300 or the neutralization settings via the operating panel 102 of the image forming apparatus 100.

As a result, it is possible to improve usability when the user performs neutralization setting. In the second embodiment, since the CPU 201 automatically switches between the first mode and the second mode, the mode setting section 153 and the mode switch 54c described in the first embodiment do not necessarily need to be provided.

In the second embodiment as well, the status line 152 displays whether the neutralization settings of the image forming apparatus 100 have priority or the neutralization settings of the static eliminator 300 have priority. The display on the status line 152 is held even when transitioning from the neutralization settings screen to another screen. As a result, the user is able to check the setting of the mode setting section 153 at any time, so usability further improves.

### Other Embodiments

In the embodiments described above, the static eliminator 300 that neutralizes a sheet S has been described, and the static eliminator 300 functions as an electric charge adjustment apparatus that adjusts the charged state of a sheet S by supplying electric charge to the sheet S through the charge eliminating roller 51b as an electric charge supply member. The electric charge adjustment apparatus does not necessarily need to reduce the amount of electric charge on (neutralize) a sheet S. For example, the electric charge adjustment apparatus may adjust the amount of electric charge on each side of a sheet S such that, after processing, in a state where the sheets S are stacked, the opposing surfaces of the overlapping sheets are charged with the same polarity. Specifically, the electric charge adjustment apparatus applies voltage so that the electrostatic polarities of the sheet surfaces reverse every other sheet. In this case, the facing surfaces of the overlapping sheets are electrostatically charged with the same polarity, so the sticking between the sheets due to the electrostatic force can be reduced.

By applying the control described in each embodiment to the control of the voltage applied to the charge eliminating roller pair 51 as an electric charge supply member, the charged state of the sheet S can be adjusted more appropriately. In other words, the mode setting section 153 is provided to switch between the first mode in which the voltage set via the operating unit 54 is applied as a voltage to be applied to the charge eliminating roller 51b and the second mode in which the voltage set via the operating panel 102 is applied as a voltage to be applied to the charge eliminating roller 51b. With this configuration, the electric charge adjustment apparatus can also improve usability when the user performs electric charge adjustment setting.

In each of the embodiments, the charge eliminating roller 51b that is a roller member has been described as an example of the contact charge eliminating component that contacts with a sheet S. The contact charge eliminating component is not limited thereto. For example, the contact charge eliminating component may be a brush member of which conductive fibers or elongated conductive sheet pieces contact with a sheet S.

In each of the embodiments described above, the charging of a sheet S occurs mainly at the transfer portion in the electrophotographic process. Not limited to this configuration, in image forming systems other than electrophotographic image forming systems, such as the inkjet image forming systems, the charging of a sheet S can occur due to triboelectric charging or separation charging caused by rubbing or separation with a conveying guide, a conveying roller, or a conveying belt. Therefore, this technology may also be applied to image forming systems other than electrophotographic image forming systems.

The present disclosure can be implemented by a process of supplying a program for implementing one or more functions of the above-described embodiments to a system or apparatus via a network or storage medium, and causing one or more processors in a computer of the system or apparatus to read and run the program. Alternatively, the present disclosure may be implemented by a circuit (for example, ASIC) that implements one or more functions.

According to the present disclosure, it is possible to improve usability when performing setting related to sheet neutralization and electric charge adjustment.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159543, filed Sep. 13, 2024, which is hereby incorporated by reference herein in its entirety.

What is claimed is:

1. An image forming system comprising:
an image forming apparatus configured to form an image on a sheet; and
a static eliminator having a charge eliminating component configured to neutralize a sheet having an image formed by the image forming apparatus, wherein
the static eliminator includes a first setting unit configured to set a voltage to be applied to the charge eliminating component,
the image forming apparatus includes a second setting unit configured to set a voltage to be applied to the charge eliminating component, and
the image forming system includes a third setting unit configured to set which voltage is applied as a voltage to be applied to the charge eliminating component, the voltage set by the first setting unit or the voltage set by the second setting unit.

2. The image forming system according to claim 1, wherein the first setting unit is a hardware unit disposed on an outer casing of the static eliminator.

3. The image forming system according to claim 1, wherein the first setting unit is a thumbwheel switch.

4. The image forming system according to claim 1, wherein the third setting unit is a hardware unit comprising a selector switch disposed on an outer casing of the static eliminator.

5. The image forming system according to claim 1, wherein the third setting unit is a control unit configured to control which voltage is applied as a voltage to be applied to the charge eliminating component, the voltage set by the first setting unit or the voltage set by the second setting unit, wherein
the control unit is configured to
when a value of the voltage set by the first setting unit is changed, apply the voltage set by the first setting unit as a voltage to be applied to the charge eliminating component, and
when a value of the voltage set by the second setting unit is changed, apply the voltage set by the second setting unit as a voltage to be applied to the charge eliminating component.

6. The image forming system according to claim 1, wherein the image forming apparatus includes a display unit configured to display information, and
the second setting unit is a software key displayed on a neutralization settings screen of the display unit.

7. The image forming system according to claim 6, wherein the display unit is configured to display which voltage is applied, the voltage set by the first setting unit or the voltage set by the second setting unit.

8. The image forming system according to claim 7, wherein the display unit is configured to display which voltage is applied, the voltage set by the first setting unit or the voltage set by the second setting unit, even after a display screen transitions from the neutralization settings screen to another screen.

9. The image forming system according to claim 1, further comprising a fourth setting unit configured to set whether to apply voltage to the charge eliminating component without changing a value of the voltage set by the first setting unit.

10. The image forming system according to claim 9, wherein
the charge eliminating component is a charge eliminating roller of a charge eliminating roller pair configured to neutralize a sheet while nipping and conveying the sheet,
the static eliminator includes a noncontact neutralizing portion disposed downstream of the charge eliminating roller pair in a sheet conveyance direction and configured to neutralize a sheet while being not in contact with the sheet, and
even when a setting by the fourth setting unit is a setting not to apply voltage to the charge eliminating roller pair, voltage is applied to the noncontact neutralizing portion.

11. The image forming system according to claim 1, wherein, when the voltage set by the first setting unit is selected by the third setting unit,
the voltage set by the first setting unit is applied as a voltage to be applied to the charge eliminating component, and the voltage set by the second setting unit is not applied, and
information about the voltage set by the second setting unit is held.

12. The image forming system according to claim 1, wherein, when the voltage set by the second setting unit is selected by the third setting unit,
the voltage set by the second setting unit is applied as a voltage to be applied to the charge eliminating component, and the voltage set by the first setting unit is not applied, and
information about the voltage set by the first setting unit is held.

13. A static eliminator for connection to an image forming apparatus that forms an image on a sheet, the static eliminator comprising:
a charge eliminating component configured to neutralize a sheet having an image formed by the image forming apparatus;
a first setting unit configured to set a voltage to be applied to the charge eliminating component; and
a third setting unit configured to set which voltage is applied as a voltage to be applied to the charge eliminating component, the voltage set by the first setting unit or a voltage set by a second setting unit disposed in the image forming apparatus and configured to set a voltage to be applied to the charge eliminating component.

14. An electric charge adjustment apparatus for connection to an image forming apparatus that forms an image on a sheet, the electric charge adjustment apparatus comprising:
an electric charge supply member configured to supply electric charge to a sheet having an image formed by the image forming apparatus;
a first setting unit configured to set a voltage to be applied to the electric charge supply member; and
a third setting unit configured to set which voltage is applied as a voltage to be applied to the electric charge supply member, the voltage set by the first setting unit or a voltage set by a second setting unit disposed in the image forming apparatus and configured to set a voltage to be applied to the electric charge supply member.
